(19) United States
(12) Patent Application Publication
(10) Pub. No.: US 2006/0019153 A1
(43) Pub. Date: Jan. 26, 2006

(54) Non-aqueous electrolyte battery

(76) Inventors: Naoki Imachi, Kobe-shi (JP); Yasuo Takano, Kobe-shi (JP); Seiji Yoshimura, Kobe-shi (JP); Shin Fujitani, Kobe-shi (JP)

Correspondence Address: KUBOVCIK & KUBOVCIK, SUITE 710, 900 17TH STREET NW, WASHINGTON, DC, 20006, US

(21) Appl. No.: 11/184,933

(22) Filed: Jul. 20, 2005

(30) Foreign Application Priority Data
Jul. 21, 2004 (JP) 2004-213111

(51) Int. Cl. H01M 4/02; H01M 10/50; H01M 4/50; H01M 2/16; H01M 4/52

(52) U.S. Cl. 429/128; 429/62; 429/224; 429/231.1; 429/231.3; 429/144

(57) ABSTRACT

A non-aqueous electrolyte battery that is capable of improving safety, particularly tolerance of the battery for overcharging, is furnished with a positive electrode including a positive electrode active material-layer (2) containing a plurality of positive electrode active materials and being formed on a surface of a positive electrode current collector (1), a negative electrode including a negative electrode active material layer (4), and a separator (3) interposed between the electrodes. The positive electrode active material-layer (2) is composed of two layers (2a) and (2b) having different positive electrode active materials, and of the two layers (2a) and (2b), the layer (2b) that is an outer layer contains as its main active material a positive electrode active material having the highest thermal stability among the positive electrode active materials. The meltdown temperature of the separator (3) is 180° C. or higher.

### BACKGROUND OF THE INVENTION

1. Field of the Invention

The present invention relates to improvements in non-aqueous electrolyte batteries, such as lithium-ion batteries and polymer batteries, and more particularly to non-aqueous electrolyte batteries that have excellent safety on overcharge.

2. Description of Related Art

Rapid advancements in size and weight reductions of mobile information terminal devices such as mobile telephones, notebook computers, and PDAs in recent years have created demands for higher capacity batteries as driving power sources for the devices. With their high energy density and high capacity, non-aqueous electrolyte batteries that perform charge and discharge by transferring lithium ions between the positive and negative electrodes have been widely used as the driving power sources for the mobile information terminal devices. Moreover, utilizing their characteristics, applications of non-aqueous electrolyte batteries, especially Li-ion batteries, have recently been broadened to middle-sized to large-sized batteries for power tools, electric automobiles, hybrid automobiles, etc. as well as mobile applications such as mobile telephones. As a consequence, demands for increased safety have been on the rise, along with demands for increased capacity and higher output power.

Many of commercially available non-aqueous electrolyte batteries, especially Li-ion batteries, adopt lithium cobalt oxide as their positive electrode active material. The energy that can be attained by lithium cobalt oxide, however, has almost reached the limit already, and therefore, to achieve higher battery capacity, it has been inevitable to increase the filling density of the positive electrode active material. Nevertheless, increasing the filling density of the positive electrode active material causes battery safety to degrade when the battery is overcharged. In other words, since there is a trade-off between improvement in battery capacity and enhancement in battery safety, improvements in capacity of the batteries have lately made little progress. Even if a new positive electrode active material that can serve as an alternative to lithium cobalt oxide will be developed in the future, the necessity of increasing the filling density of the positive electrode active material to achieve a further higher capacity will still remain the same because the energy that can be attained by that newly developed active material will also reach the limit sooner or later.

Conventional unit cells incorporate various safety mechanisms such as a separator shutdown function and additives to electrolyte solutions, but these mechanisms are designed assuming a condition in which the filling density of active material is not very high. For that reason, increasing the filling density of active material as described above brings about such problems as follows. Since the electrolyte solution's infiltrating performance into the interior of the electrodes is greatly reduced, reactions occur locally, causing lithium to deposit on the negative electrode surface. In addition, the convection of electrolyte solution is worsened and heat is entrapped within the electrodes, worsening heat dissipation. These prevent the above-mentioned safety mechanisms from fully exhibiting their functions, leading to further degradation in safety. Thus, it is necessary to establish a battery construction that can make full use of those safety mechanisms without considerably compromising conventional battery constructions.

To resolve the foregoing problems, various techniques have been proposed. For example, Japanese Published Unexamined Patent Application No. 2001-143705 proposes a Li-ion secondary battery that has improved safety using a positive electrode active material in which lithium cobalt oxide and lithium manganese oxide are mixed. Japanese Published Unexamined Patent Application No. 2001-143708 proposes a Li-ion secondary battery that improves storage performance and safety using a positive electrode active material in which two layers of lithium-nickel-cobalt composite oxides having different compositions are formed. Japanese Published Unexamined Patent Application No. 2001-338639 proposes a Li-ion secondary battery in which, for the purpose of enhancing battery safety determined by a nail penetration test, a plurality of layers are formed in the positive electrode and a material with high thermal stability is disposed in the lowermost layer of the positive electrode, to prevent the thermal runaway of the positive electrode due to heat that transfers via the current collector to the entire battery.

The above-described conventional batteries have the following problems.

(1) JP 2001-143705A

Merely mixing lithium cobalt oxide and lithium manganese oxide cannot fully exploit the advantage of lithium manganese oxide, which has excellent safety. Therefore, a significant improvement in safety cannot be attained.

(2) JP 2001-143708A

With lithium-nickel-cobalt composite oxide, lithium ions that can be extracted from its crystals exist in the crystals when overcharged, and the lithium can deposit on the negative electrode and become a source of heat generation. For this reason, safety on overcharge, etc., cannot be improved sufficiently.

(3) JP 2001-338639A

The above-described construction is intended for merely preventing the thermal runaway of a battery due to heat dissipation through the current collector under a certain voltage, and is not effective in preventing the thermal runaway of an active material that originates from deposited lithium on the negative electrode such as when overcharged.

### BRIEF SUMMARY OF THE INVENTION

Accordingly, it is an object of the present invention to provide a non-aqueous electrolyte battery that achieves improvements in safety, particularly in tolerance of the battery for overcharging, without considerably compromising conventional battery constructions.

In order to accomplish the foregoing and other objects, the present invention provides a non-aqueous electrolyte battery, comprising: a positive electrode including a positive electrode active material-layer and a positive electrode current collector, the positive electrode active material-layer formed on a surface of the positive electrode current collector and comprising a plurality of layers respectively having different positive electrode active materials, wherein an outermost positive electrode layer among the plurality of layers contains as its main active material a positive electrode active material having the highest thermal stability among the positive electrode active materials; a negative electrode including a negative electrode active material layer; and a separator interposed between the electrodes and having a meltdown temperature of 180° C. or higher.

The above-described construction enables the reaction between the electrolyte solution and the active material in the outermost surface layer of the positive electrode to occur actively in the event of overcharge, inhibiting the charge reaction with the rest of the active material existing within an inner region of the positive electrode from easily proceeding. In this case, because the positive electrode active material in the outermost surface layer of the positive electrode contains as its main active material a positive electrode active material having the highest thermal stability among the positive electrode active materials, thermal runaway can be prevented even if the reaction actively occurs. Moreover, although the active material in the interior of the positive electrode decomposes and consumes the electrolyte solution as a side reaction upon reaching an overcharge region, the decomposition of the electrolyte solution actively proceeds in the outermost positive electrode active material layer, inhibiting excessive electrolyte solution within the battery from easily infiltrating into the interior of the positive electrode. Consequently, the interior of the positive electrode tends to experience a shortage of electrolyte solution, thereby preventing the thermal runaway of the active material that exists in the interior of the positive electrode. Thus, the amount of heat generated from the battery as a whole can be lowered.

In addition, by restricting the meltdown temperature of the separator to 180° C. or higher, the separator does not easily melt down even if an exothermic reaction occurs locally within the battery, because the melting temperature of the separator is set higher than that of the normally-used microporous polyethylene film. Thus, internal short circuits of the battery can be prevented from occurring.

The improvement in the positive electrode structure as described above can reduce the total amount of heat generated from the battery, and the improvement in the separator can prevent internal short circuits of the battery. Owing to the synergistic effect of these effects, tolerance of the battery for overcharging improves dramatically.

### BRIEF DESCRIPTION OF THE DRAWINGS

FIG. 1 is a view illustrating a heat transfer passage in a conventional positive electrode;

FIG. 2 is a view illustrating a heat transfer passage in the present invention;

FIG. 3 is a view illustrating a power-generating element of the present invention;

FIG. 4 is a view illustrating the state of a local exothermic reaction;

FIG. 5 is a plan view of a test cell for evaluating SD temperature and MD temperature of a separator;

FIG. 6 is a cross-sectional view of the test cell;

FIG. 7 is a graph showing the relationship between charge time, battery voltage, current, and battery temperature in Battery A3 of the invention; and

FIG. 8 is a graph showing the relationship between charge time, battery voltage, current, and battery temperature in Comparative Battery X4.

### DETAILED DESCRIPTION OF THE INVENTION

Herein, the present invention as summarized above is described more specifically in comparison with the technique disclosed in JP 2001-338639A (hereinafter simply referred to as the “conventional technique”), which is described above in the “Background of the Invention.”

(1) Difference in Reaction Modes Between the Conventional Technique and the Present Invention

The conventional technique employs a so-called static test, in which heat generation of a battery is caused by simply sticking a nail into the battery without accompanying a charge reaction. In contrast, the present invention adopts a so-called dynamic test, in which heat generation of a battery is caused by actually charging the battery. Specifically, the differences are as follows.

(I) Although both techniques deal with the problem of thermal runaway caused by heat generation of a battery, the conventional technique does not take a charge-discharge reaction into consideration, so the reaction takes place relatively uniformly in locations other than the location in which a nail is stuck. On the other hand, with the present invention, the electrolyte solution undergoes a decomposition reaction due to an actual charging operation, resulting in a gas formation. Therefore, the electrode reaction (charge reaction) becomes non-uniform, creating variations in the reaction from one location to another in the electrodes.

(II) The conventional technique is free from the problem of deposited lithium, so it is only necessary to take the thermal stability of the positive electrode into consideration. In contrast, since the present invention involves a charge reaction, the problem of dendrite due to the deposited lithium arises.

(III) Since the conventional technique does not involve a charge reaction, the thermal stability of the active material does not change over time. In contrast, because the present invention involves a charge reaction, the thermal stability of the active material varies greatly depending on the charge depth. Specifically, the greater the charge depth, the lower the stability of the active material.

As discussed in the foregoing (I) and (II), the reaction modes greatly differ between the conventional technique and the present invention, and therefore, it is obvious that a construction that is effective in the nail penetration test is not necessarily also effective in the overcharging test. Moreover, because of the differences in the reaction modes, the conventional technique does not take into consideration the problems of meltdown and heat shrinkage of the separator. Furthermore, concerning the problem of thermal stability of active material as discussed in the foregoing (III) as well, the operations and advantageous effects will not be the same since there are differences in static or dynamic concepts between the conventional technique and the present invention.

(2) Difference in Thermal Transfer Passage Between the Conventional Technique and the Present Invention

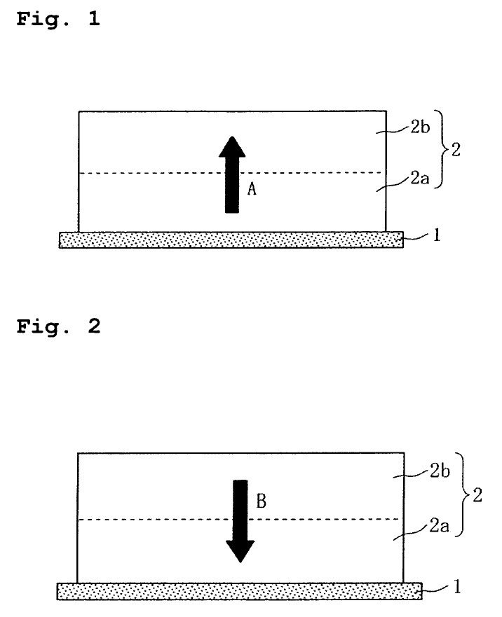

In the conventional technique, as described in the specification, generated heat spreads over the entire battery through the nail and the aluminum current collector, which have high thermal conductivities and thus serve as heat conductors. That is, as illustrated in FIG. 1, the heat transfers from a lower layer 2a toward an upper layer 2b (in the direction indicated by the arrow A) in a positive electrode active material 2. For this reason, the conventional technique employs a construction in which a material having a higher thermal stability is arranged in the lower layer. On the other hand, in the present invention, what causes a reaction initially when overcharged is lithium deposited on the negative electrode surface. Therefore, as illustrated in FIG. 2, heat transfers from the upper layer 2b toward the lower layer 2a (in the direction indicated by the arrow B) in the positive electrode active material 2. In FIGS. 1 and 2, reference numeral 1 denotes a positive electrode current collector.

(3) Characteristic Features of the Present Invention Based on the Differences Discussed Above

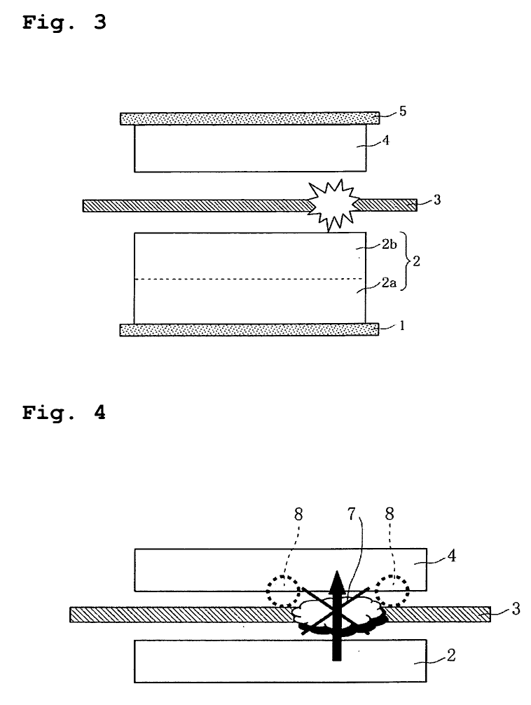

When taking improvement in tolerance of the battery for overcharging into consideration, it is effective to employ a construction in which the outermost positive electrode layer (the upper layer 2b in FIG. 3) contains as its main active material a positive electrode active material that has the highest thermal stability on overcharge among the positive electrode active materials, as illustrated in FIG. 3. (In FIG. 3, the parts having the same functions as those in FIGS. 1 and 2 are designated by the same reference characters. The same reference characters are also used in FIG. 4, which will be discussed later.) That is, the present invention utilizes a completely different construction from the construction of the conventional technique.

With the foregoing configuration, during overcharge, a reaction occurs between the electrolyte solution and the active material of the upper layer 2b, which has the highest thermal stability, making the charge reaction of the lower layer 2a difficult to proceed. Moreover, since the decomposition of the electrolyte solution actively proceeds in the upper layer 2b of the positive electrode active material-layer, excessive electrolyte solution within the battery is inhibited from easily infiltrating into the interior of the positive electrode. Thus, thermal runaway of the positive electrode active material of the lower layer 2a is prevented.

Nevertheless, utilizing the above-described positive electrode structure alone does not improve tolerance of the battery for overcharging. This is due to the following reasons. When current collection performance between the positive and negative electrodes lowers due to the gas generation that originates from the decomposition of the electrolyte solution (i.e., the reaction area decreases) or the amount of the electrolyte solution decreases within the electrodes due to the reaction of the electrolyte solution, an exothermic reaction occurs locally in a peripheral region in which these behaviors take place (locations indicated by reference numeral 8 in FIG. 4, wherein the behavior take place at a location 7). (It is believed that the heat originating from the deposited lithium alone can bring the temperature to about 165° C. locally). Thereby, the separator melts down (commonly-used polyethylene separators melt down at about 165° C.), causing internal short circuits.

In view of this, restricting the separator meltdown temperature to be 180° C. or higher to prevent internal short circuits together with adopting the above-described positive electrode structure, as in the present invention, makes it possible to improve tolerance of the battery for overcharging.

In the non-aqueous electrolyte battery of the present invention, the main positive electrode active material in the outermost positive electrode layer may be a spinel-type lithium manganese oxide.

The spinel-type lithium manganese oxide deintercalates most of the lithium ions from the interior of the crystals during charge to 4.2 V, and almost no lithium ions can be extracted from the interior of the crystals even when overcharged beyond 4.2 V. Thus, its thermal stability is very high. Moreover, the spinel-type lithium manganese oxide is well-known as an oxidizing agent for chemical substances, and it exhibits a state close to manganese dioxide during charge and therefore has a very strong oxidizing power. Accordingly, the advantageous effects of the invention can be more effectively exhibited.

In the non-aqueous electrolyte battery of the present invention, the positive electrode active material of the outermost positive electrode layer may consist of a spinel-type lithium manganese oxide.

This configuration can make use of the advantages of the spinel-type lithium manganese oxide more effectively, and therefore, the advantageous effects of the invention become greater.

In the non-aqueous electrolyte battery of the present invention, the positive electrode active material-layer may contain lithium cobalt oxide as a positive electrode active material.

Lithium cobalt oxide has a large capacity per unit volume. Therefore, when the positive electrode active material contains lithium cobalt oxide as described above, enhancement of battery capacity is possible.

In the non-aqueous electrolyte battery of the present invention, the lithium cobalt oxide may exist in a lowermost positive electrode layer.

When lithium cobalt oxide, which is a source of thermal runaway, exists in the lowermost positive electrode layer as described above, a reaction occurs actively between the electrolyte solution and the active material existing on the positive electrode surface in an overcharged state, making the charge reaction with the lithium cobalt oxide difficult to proceed. Moreover, although lithium cobalt oxide decomposes and consumes the electrolyte solution by a side reaction upon reaching an overcharge region, the decomposition of the electrolyte solution actively proceeds in the outermost positive electrode active material layer, inhibiting excessive electrolyte solution within the battery from easily infiltrating into the interior of the positive electrode. Consequently, the interior of the positive electrode tends to experience a shortage of electrolyte solution, preventing the thermal runaway of the lithium cobalt oxide that exists in the interior of the positive electrode. Thus, the amount of heat generated from the battery as a whole is lowered.

In the non-aqueous electrolyte battery of the present invention, the total mass of the lithium cobalt oxide in the positive electrode active-material layer may be greater than the total mass of the spinel-type lithium manganese oxide in the positive electrode active material-layer.

Restricting the total mass of the lithium cobalt oxide to be greater than the total mass of the spinel-type lithium manganese oxide as in the foregoing configuration can increase the energy density of the battery as a whole, because the lithium cobalt oxide has a greater specific capacity than the spinel-type lithium manganese oxide.

In the non-aqueous electrolyte battery of the present invention, the separator may be an electron-beam cross-linked separator, in which cross-linking is effected by irradiating a microporous polyethylene film with an electron beam.

Although the electron-beam cross-linking of the separator can result in a higher meltdown temperature than non-cross-linked polyethylene separators, it does not at all affect other physical properties of the separator (for example, shutdown temperature, etc.). Consequently, meltdown of the separator can be prevented while its shutdown function is sufficiently exhibited.

In the non-aqueous electrolyte battery of the present invention, the separator may comprise a microporous film having a melting point of 200° C. or higher and a microporous polyethylene film, the microporous film having a melting point of 200° C. or higher stacked over the microporous polyethylene film.

The use of the heat-proof layer-stacked separator can attain a further higher separator meltdown temperature, preventing separator meltdown more effectively.

In the non-aqueous electrolyte battery of the present invention, the microporous film having a melting point of 200° C. or higher may be a microporous film made of polyamide, polyimide, or polyamideimide.

Examples of the polyamide include those having the structures as shown below. In the following structural formulae, R and R′ represent an aliphatic hydrocarbon group or an aromatic hydrocarbon group.

[symbol]

R—(C═O)—NH—]ₙ— [symbol]
NR—(C═O)—]ₙ— [symbol]
R—(C═O)—NH—R′—NH—(C═O)—]ₙ—

Examples of the polyimide include those having the structure as shown below. In the following structural formula, R and R′ represent an aliphatic hydrocarbon group or an aromatic hydrocarbon group.

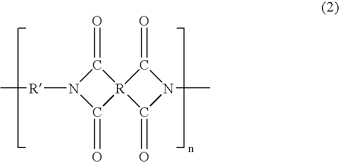

Examples of the polyamideimide include those having the structure as shown below.

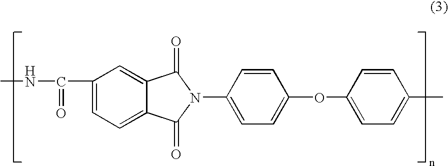

In the above structural formulae that represent the polyamide, polyimide, and polyamideimide, the number n, which denotes degree of polymerization, is not particularly limited, but generally, it is preferable that n is about 50 to about 10000. More preferably, the heat-proof layer in the present invention is comprised of a material represented by the formula
—[—CH₂—CH₂—C₆H₄—CH₂—(C═O) NH—]ₙ—
having a melting point of 200° C. to less than 400° C. It is particularly preferable that the heat-proof layer in the present invention be formed of a para-aromatic polyamide.

The microporous film made of polyamide, polyimide, or polyamideimide is offered as an illustrative example of the microporous film having a melting point of 200° C. or higher, but this is not intended to be limiting of the present invention.

In the non-aqueous electrolyte battery of the present invention, the microporous film made of polyamide, polyimide, or polyamideimide may have a melting point of from 200° C. to 400° C.

In the present invention, the thickness of the heat-proof layer is 1 μm to 10 μm, more preferably 1 μm to 5 μm. When the thickness of the heat-proof layer is too small, the advantage of the heat-proof layer, that is, reduction of the heat shrinkage ratio, may not be sufficiently obtained. On the other hand, when the thickness of the heat-proof layer is too large, the separator tends to curl due to the difference in shrinkage characteristics between the polyolefin layer and the heat-proof layer. There is no particular limitation of the pore-size in the heat-proof layer. But it is preferable to adjust the pore-size in the heat-proof layer such that the air permeability of the separator in which the polyolefin layer and the heat proof layer are stacked is 100 to 300 sec/100 mL (measured according to JIS P8117).

The present invention achieves the advantageous effect of improvement in safety, particularly in tolerance of the battery for overcharging, without considerably changing conventional battery constructions.

### DESCRIPTION OF PREFERRED EMBODIMENTS

Hereinbelow, the present invention is described in further detail based on preferred embodiments thereof. It should be construed, however, that the present invention is not limited to the following preferred embodiments but various changes and modifications are possible without departing from the scope of the invention.

Preparation of Positive Electrode

First, lithium cobalt oxide (hereinafter also abbreviated as “LCO”), used as a positive electrode active material, and SP300 (conductive agent: made by Nippon Graphite Industries, Ltd.) and acetylene black, used as carbon conductive agents, were mixed together at a mass ratio of 92:3:2 to prepare a positive electrode mixture powder. Next, 200 g of the resultant powder was charged into a mixer (for example, a mechanofusion system AM-15F made by Hosokawa Micron Corp.), and the mixer was operated at a rate of 1500 rpm for 10 minutes to cause compression, shock, and shear actions while mixing, to prepare a positive electrode active material mixture. Subsequently, the resultant positive electrode, active material mixture and a fluoropolymer-based binder agent (PVDF) were mixed at a mass ratio of 97:3 in N-methyl-2-pyrrolidone (NMP) solvent to prepare a positive electrode slurry. Thereafter, the positive electrode slurry was applied onto both sides of an aluminum foil, serving as a positive electrode current collector, and the resultant material was then dried and pressure-rolled. Thus, a first positive electrode active material layer was formed on a surface of the positive electrode current collector.

Subsequently, another positive electrode slurry was prepared in the same manner as described above except that a spinel-type lithium manganese oxide (which hereinafter may be abbreviated to as “LMO”) was used as the positive electrode active material. Further, the positive electrode slurry was applied onto the first positive electrode active material layer, and the resultant material was dried and pressure-rolled, whereby a second positive electrode active material layer was formed on the first positive electrode active material layer.

The foregoing procedure resulted in a positive electrode. The mass ratio of the respective positive electrode active materials in the positive electrode was LCO:LMO=70:30.

Preparation of Negative Electrode

A carbon material (graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and rolled. Thus, a negative electrode was prepared.

Preparation of Non-aqueous Electrolyte Solution

LiPF₆ was dissolved at a concentration of 1.0 mole/L in a mixed solvent of 3:7 volume ratio of ethylene carbonate (EC) and diethyl carbonate (DEC) to prepare a non-aqueous electrolyte solution.

Preparation of Separator

A separator was prepared by irradiating a commonly-used polyethylene (hereinafter also abbreviated as “PE”) microporous film with an electron beam. Irradiating the commonly-used separator with an electron beam in this way causes the PE to form a cross-linked structure, thereby yielding an electron beam cross-linked separator. The film thickness of the separator was 16 μm.

Construction of Battery

Lead terminals were attached to the positive and negative electrodes, and the positive and negative electrodes were wound in a spiral form with the separator interposed therebetween. The wound electrodes were then pressed into a flat shape to obtain a power-generating element, and thereafter, the power-generating element was accommodated into an enclosing space made by an aluminum laminate film serving as a battery case. Then, the non-aqueous electrolyte solution was filled into the space, and thereafter the battery case was sealed by welding the aluminum laminate film. Thus, a battery was fabricated.

The foregoing battery had a design capacity of 650 mAh.

### EXAMPLES

Preliminary Experiment

Shutdown temperature (hereinafter also referred to as “SD temperature”) and meltdown temperature (hereinafter also referred to as “MD temperature”) were investigated with the foregoing electron beam cross-linked separator (utilized in later-described Batteries A1 A3, B1, and C1 of the invention, as well as Comparative Batteries X4, Y3, and Z3), a heat-proof layer-stacked separator (utilized in later-described Batteries A2 and A4 of the invention, and Comparative Battery X5), and an ordinary separator (used in later-described Comparative Batteries X1 to X3, Y1, Y2, Z1, and Z2). The results are shown in Table 1. The method of fabricating test cells, the evaluation equipment, and the method of measuring SD temperature and MD temperature were as follows.

Fabrication Method of Test Cell

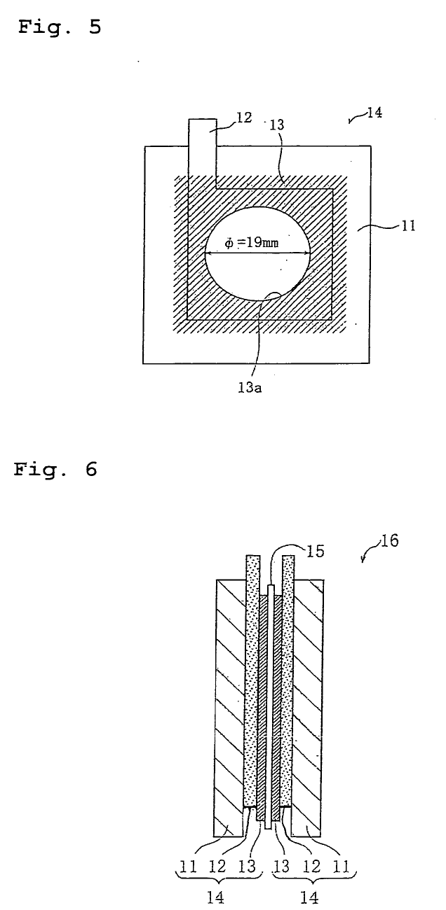

As illustrated in FIG. 5, a substantially square-shaped aluminum foil 12 (thickness: 15 μm) was disposed on one side of a glass substrate 11, and a poly-imide tape 13 was affixed to and partially covers the surface of the aluminum foil 12 to produce a cell piece 14. Two cell pieces 14 were prepared, and as illustrated in FIG. 6, a sample of the foregoing separators 15 was placed between the two cell pieces 14, 14, which were fastened by clips, to prepare a test cell 16.

The poly-imide tape 13 was affixed to prevent short-circuiting due to burrs, and a 19-mm diameter hole 13a was formed at approximately the center of the poly-imide tape 13.

The electrolyte solution of the test cell 16 used was γ-butyrolactone in which LiBF₄ as a solute was dissolved in at a concentration of 0.5 mole/liter and 1 mass % of trioctyl phosphate as a surfactant was added to ensure wettability. This electrolyte solution was used taking into consideration the stability and boiling point of the solvent under heating to 200° C. or higher.

Evaluation Equipment

Electric furnace AMF-10 and digital temperature controller AMF-2P (temperature accuracy: ±1° C./min), made by Asahi Rika Seikakusho Co., Ltd.

LCR meter 3522 made by Hioki E. E. Corp.

Measurement of SD (Shutdown) Temperature and MD (Meltdown), Temperature

Using the foregoing test cell 16, a measurement was conducted to study the physical properties of the separators under the condition in which a temperature elevation rate is fast (20° C./min, assuming an actual overcharge condition).

While the temperature was elevated from room temperature to about 210° C. at the foregoing temperature elevation rate, a change in the resistance value between the electrodes was measured. A temperature obtained at the time when the resistance value greatly increased (due to clogging of micropores in the separator caused by melting of the fuse component, i.e., low-melting point component) was determined as the SD temperature, and a temperature obtained at the time when the resistance value dropped (due to the contact between the electrodes caused by melting down of the separator) was determined as the MD temperature.

TABLE 1

| Separator type | SD temperature | MD temperature |
|---|---|---|
| Electron beam cross- | 140° C. | 185° C. |
| linked separator | | |
| Heat-proof layer | 140° C. | 200° C. or higher |
| stacked separator | | |
| Conventional separator | 140° C. | 165° C. |

Table 1 clearly shows that all the separators had an SD temperature of 140° C. On the other hand, it is appreciated that the ordinary separator showed an MD temperature of 165° C., while the electron beam cross-linked separator and the heat-proof layer-stacked separator exhibited higher temperatures, 185° C. and 200° C. or higher, respectively.

### FIRST EMBODIMENT

### Example A1

A battery fabricated according to the foregoing embodiment was used as Example A1.

The battery thus fabricated is hereinafter referred to as Battery A1 of the invention.

### Example A2

A battery was fabricated in the same manner as in Example A1 above, except that a heat-proof layer-stacked separator was used in place of the electron beam cross-linked separator.

The battery thus fabricated is hereinafter referred to as Battery A2 of the invention.

Herein, the heat-proof layer-stacked separator was fabricated in the following manner.

First, polyamide (PA), which is a water-insoluble, heat-resistant material, was dissolved in N-methyl-2-pyrrolidone (NMP) solution, which is a water-soluble solvent, and the resultant solution underwent low-temperature condensation polymerization to prepare a polyamide-doped solution. Next, this doped solution was coated on one side of a polyethylene (PE) microporous film that is a substrate material to a predetermined thickness, and thereafter the coated substrate was immersed in water to remove the water-soluble NMP solvent and deposit/solidify the water-insoluble polyamide. Thus, a microporous polyamide film was formed on one side of the polyethylene film. Then, the microporous polyamide film was dried at a temperature lower than the melting point of polyethylene (specifically, at 80° C.) to remove water therefrom, and thus, a separator comprising a stack of microporous films was obtained. It should be noted that the number and size of pores in the polyamide film can be varied by varying the concentration of polyamide in the water-soluble solvent. The film thickness of the separator was 18 μm (PE layer: 16 μm, PA layer: 2 μm).

### Example A3

A battery was fabricated in the same manner as in Example A1 above, except that a mixture of LCO and LMO was used in place of LCO alone as the positive electrode active material of the first positive electrode active material layer (the inner layer of the positive electrode active material-layer) in the positive electrode.

The battery thus fabricated is hereinafter referred to as Battery A3 of the invention.

### Example A4

A battery was fabricated in the same manner as in Example A2 above, except that a mixture of LCO and LMO was used in place of LCO alone as the positive electrode active material of the first positive electrode active material layer (the inner layer of the positive electrode active material layer) in the positive electrode.

The battery thus fabricated is hereinafter referred to as Battery A4 of the invention.

### Comparative Examples X1 and X2

Batteries were fabricated in the same manners as in Examples 1 and 3, respectively, except that an ordinary separator (a 16-μm thick separator made of PE alone and not cross-linked with an electron beam) was used as the separator, in place of the electron beam cross-linked separator.

The batteries thus fabricated are hereinafter referred to as Comparative Batteries X1 and X2, respectively.

### Comparative Examples X3 to X5

Batteries were fabricated in the same manners as in Comparative Example 1, and Examples 1 and 2, respectively, except that a single layer structure was adopted for the positive electrode active material-layer, instead of the double layer structure as described above (a mixture of LCO and LMO was used as the positive electrode active materials).

The batteries thus fabricated are hereinafter referred to as Comparative Batteries X3 to X5, respectively.

Experiment

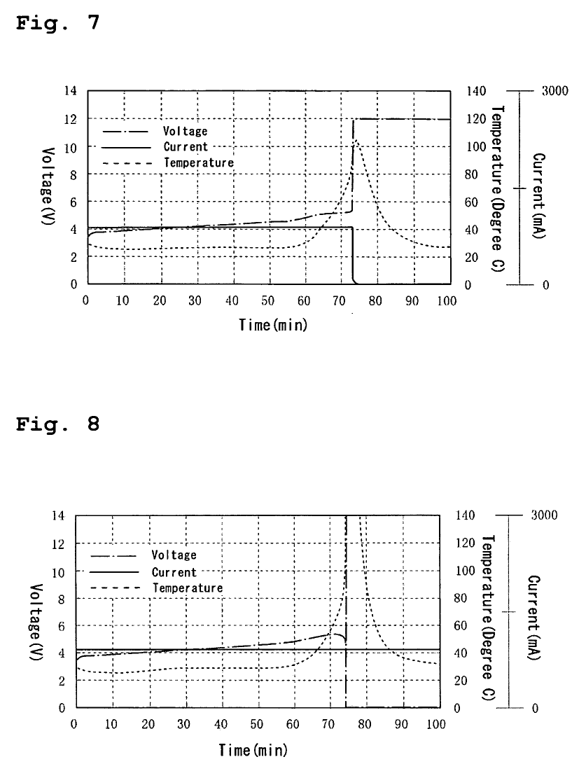

The tolerance for overcharging of Batteries A1 to A3 of the invention and Comparative Batteries X1 to X5 were studied. The results are shown in Table 2. The conditions of the experiment were as follows. Samples of the respective batteries were subjected to a charge test using circuits that charge the batteries at respective currents of 1.0 C, 1.5 C, 2.0 C, and 2.5 C until the battery voltages reached 12 V, with 1.0 C being defined as 600 mA, and then the batteries were charged at a constant voltage (without a lower limit of current). After a voltage of 12 V was reached, the charging was continued for 3 hours. With Battery A3 of the invention and Comparative Battery X4, the relationships of current, voltage, and temperature with respect to charge time were studied by overcharging the batteries at a current of 1.5 C (900 mA). The results for Battery A3 of the invention and Comparative Battery X4 are illustrated in FIGS. 7 and 8, respectively.

Usually, a battery (battery pack) is provided with a protection circuit or a protective device such as a PTC device so that the safety of the battery in abnormal conditions is ensured. For unit cells as well, various safety mechanisms are provided such as a separator shutdown function (the function to effect insulation between the positive and negative electrodes by heat-clogging pores in the microporous film) and additives to electrolyte solution so that the safety can be ensured even without the protection circuit and so forth. In the experiment, the materials and mechanisms for improving the safety were eliminated except for the separator shutdown function to prove the superiority in safety of the batteries of the invention, and the behaviors of the batteries on overcharge were studied.

TABLE 2

| | | Positive electrode active material | | | | | | |
|---|---|---|---|---|---|---|---|---|
| | | Second positive | First positive | | Number of batteries with short | | | |
| | | electrode | electrode active | | circuit | | | |
| | Positive | active material | material layer | | 1.0 C | 1.5 C | 2.0 C | 2.5 C |
| | electrode | layer (Outer | (Current | | over- | over- | over- | over- |
| Battery | structure | side) | collector side) | Separator | charge | charge | charge | charge |
| Battery A1 | Double | LMO | LCO | Electron beam | No | No | No | 1/3 |
| | layer | | | cross-linked | | | | |
| | | | | separator | | | | |
| Battery A2 | Double | LMO | LCO | Heat-proof-layer | No | No | No | No |
| | layer | | | stacked separator | | | | |
| Comparative | Double | LMO | LCO | Ordinary | No | 2/3 | 3/3 | 3/3 |
| Battery X1 | layer | | | separator | | | | |
| Battery A3 | Double | LMO | LMO/LCO | Electron beam | No | No | 1/3 | 1/3 |
| | layer | | mixed | cross-linked | | | | |
| | | | | separator | | | | |
| Battery A4 | Double | LMO | LMO/LCO | Heat-proof-layer | No | No | No | No |
| | layer | | mixed | stacked separator | | | | |
| Comparative | Double | LMO | LMO/LCO | Ordinary | No | 3/3 | 3/3 | 3/3 |
| Battery X2 | layer | | mixed | separator | | | | |

| | | | | | | | |
|---|---|---|---|---|---|---|---|
| Comparative | Single | LMO/LCO mixed | Ordinary | No | 3/3 | 3/3 | 3/3 |
| Battery X3 | layer | | separator | | | | |
| Comparative | Single | LMO/LCO mixed | Electron beam | No | 3/3 | 3/3 | 3/3 |
| Battery X4 | layer | | cross-linked | | | | |
| | | | separator | | | | |
| Comparative | Single | LMO/LCO mixed | Heat-proof-layer | No | 2/3 | 3/3 | 3/3 |
| Battery X5 | layer | | stacked separator | | | | |

With all the batteries, the mass ratio of LCO (LiCoO₂) and LMO (LiMn₂O₄) in the positive electrode active material was 70:30.

Table 2 clearly demonstrates that, with Batteries A1 to A4 of the invention, only one sample from Battery A3 caused a short circuit on overcharge at 2.0 C and only one sample from each of Batteries A1 and A3 caused a short circuit on overcharge at 2.5 C. In contrast, many samples of Comparative Batteries X1 to X5 caused short circuits on overcharge at 1.5 C, and all the samples caused short circuits on overcharge at 2.0 C.

As clearly seen from FIGS. 7 and 8, the shutdown operation started at about 73 minutes of charge time (charge capacity ratio: about 168%) in both Battery A3 of the invention and Comparative Battery X4 and the charge depths up to the shutdown were the same. Therefore, it is estimated that the amounts of lithium deposited in both batteries were approximately the same. Nevertheless, the total amount of heat generated in Battery A3 of the invention was less than that in Comparative Battery X4 because it is believed that Battery A3 of the invention successfully lowered the heat generation originating from the positive electrode in comparison with Comparative Battery X4. It should be noted that the temperatures plotted in the graphs indicate the temperatures of the battery surfaces, which have a temperature difference of 30° C. or greater from the portions with the highest temperatures within the batteries. It is believed that this indicates the local reaction that brings about the meltdown phenomenon.

Herein, it is believed that the improvements in tolerance for overcharging with Batteries A1 to A4 of the invention over Comparative Batteries X1 to X5 were due to (1) the effects originating from their positive electrode structures and (2) the effects originating from their separator structures.

(1) Effects Originating From Positive Electrode Structures

The LMO active material is well-known as an oxidizing agent for chemical substances, and it exhibits a state close to manganese dioxide during charge and, therefore, has a very strong oxidizing power. Moreover, the LMO active material deintercalates most of the lithium ions from the interior of the crystals during charge at 4.2 V, and therefore almost no lithium ions can be extracted from the interior of the crystals even when overcharged beyond 4.2 V. Thus, the LMO active material has very high thermal stability.

On the other hand, the LCO active material deintercalates only about 60% of lithium ions within the interior of the crystals when charged to 4.2 V, so the remaining about 40% of lithium ions can be extracted from the interior of the crystals when overcharged. That portion of lithium ions is not inserted into the negative electrode, resulting in deposited lithium on the negative electrode surface. In particular, during high-rate charging, the lithium-ion accepting performance of the negative electrode reduces, leading to a further increase of the deposited lithium. Since tetravalent cobalt cannot exist stably, CoO₂ is unable to exist in a stable state, and it releases oxygen from the interior of the crystals on overcharge so that it changes into a more stable crystal form. At this stage the presence of electrolyte solution tends to cause a violent exothermic reaction, which becomes a cause of thermal runaway. The oxygen released from the positive electrode assists the inflammable gas produced by the decomposition of electrolyte solution to catch fire more easily.

Here, if the LMO active material exists as the positive electrode active material of the outermost positive electrode layer as in Batteries A1 to A4 of the invention, a reaction occurs between the electrolyte solution and the active LMO active material at the positive electrode surface during overcharge, preventing the charge reaction with the rest of the active material that exists in the interior of the positive electrode (the LCO active material, or a mixed active material of the LCO active material and the LMO active material) from proceeding easily. In this case, the LMO active material has high thermal stability even in an overcharge region and, unlike the LCO active material, does not easily cause thermal runaway (thermal mode) even under the presence of electrolyte solution. Therefore, an exothermic reaction does not easily occur even in an environment in which a fresh electrolyte solution exists in the surroundings. In addition, although the active material (LCO active material) in the interior of the positive electrode decomposes and consumes the electrolyte solution as a side reaction upon reaching an overcharge region, the decomposition of the electrolyte solution actively proceeds in the LMO active material in the positive electrode, and, therefore, excessive electrolyte solution within the battery is inhibited from infiltrating into the interior of the positive electrode easily. Consequently, the interior of the positive electrode tends to experience a shortage of electrolyte solution, thereby preventing the thermal runaway of the LCO active material that exists in the interior of the positive electrode. Thus, the amount of heat generated from the battery as a whole can be lowered.

For the foregoing reasons, the safety on overcharge improves in Batteries A1 to A4 of the invention.

(2) Effects Originating From Separator Structure

In an overcharge region, an electrode reaction tends to occur unevenly because of uneven distribution of electrolyte retention within the electrodes, which is caused by gas generation by side reactions and decomposition of electrolyte solution, and especially in the location where the reaction occurs unevenly, an abnormal temperature increase tends to occur due to an increase in the amount of deposited lithium or the gathering of current, resulting in a local reaction within the battery. Because of the properties of polyethylene, the microporous polyethylene film commonly-used for separators melts at about 165° C., so it is not effective for the local exothermic reaction within the battery and meltdown of the separator easily occurs. For that reason, when an ordinary polyethylene separator is used, an improvement in tolerance of the batteries for overcharging is impossible even with the use of the double-layer positive electrode active material in which the active material of the outermost positive electrode layer employs the LMO active material. This is clear the fact that Comparative Batteries X1 and X2 caused short circuits at a current of 1.5 C or higher.

In contrast, when an electron beam cross-linked separator or a heat-proof layer-stacked separator is used as a separator, the separator does not melt down easily even if a local exothermic reaction occurs within the battery, because the melting temperatures of those separators are higher than that of the commonly-used microporous polyethylene film. Thus, using the separators with the above-described constructions enables a dramatic improvement in tolerance of the batteries for overcharging owing to the synergistic effect with the double-layer positive electrode in which the active material of the outermost positive electrode layer uses the LMO active material. This is clear from the fact that Batteries A1 to A4 of the invention caused very few short circuits at a current of 1.5 C or higher.

Nevertheless, even with the use of these separators, no significant differences were observed if the positive electrode did not employ the above-described structure. This is clear from the fact that the tolerance for overcharging of Comparative Batteries X4 and X5 were not so different from that of Comparative Battery X3. It is believed that these results are attributed to the differences in the amounts of overall heat generated from the batteries. Specifically, the separator is in contact with both the positive electrode surface and the negative electrode surface; this means that the separator is affected particularly easily in the overcharge test, in which an exothermic reaction tends to take place at the surfaces. It is believed that when the total amount of heat generated is great, other short circuit modes may also occur, in which even a small amount of deposited lithium causes dendrite short circuits, since heat shrinkage of the separator or degradation in the separator strength by the overheating become more problematic. In particular, with the positive electrode construction in the present invention, the charge depth on overcharge is approximately the same as that in the Comparative Batteries, and the amount of dendrite that deposits on the negative electrode is believed to be similar to that in the Comparative Batteries. Thus, dendrite short circuits tend to occur.

Taking the foregoing into consideration, the fact that there was little difference in tolerance for overcharging between Comparative Batteries X4 and X5 and Comparative Battery X3 probably means that the film breakage occurred due to degradation in piercing strength, etc., of the separator under the heated condition, not the meltdown of the separator due to heat. It should be noted that this kind of film breakage tends to occur more easily at high temperatures because the strength of separator degrades as the temperature at heating becomes higher.

Consequently, it is believed that although effective in preventing the film breakage due to local heating, changing the design of the separator alone is not so effective in preventing the piercing film breakage due to deposited lithium. Thus, such high occurrence rates of short circuits resulted.

(3) CONCLUSION

As described above, the total amount of the heat generated overall from a battery can be lowered owing to the effects originating from the positive electrode structures, and the separator meltdown temperature can be raised owing to the effects originating from the separator structures. The synergistic effect of these effects results in a dramatic improvement in tolerance of the battery for overcharging.

(4) Additional Remarks on Differences Between Electron Beam Cross-Linked Separator and Heat-Proof Layer-Stacked Separator

Although both the electron beam cross-linked separator and the heat-proof layer-stacked separator result in similar advantageous effects in terms of improvement in meltdown temperature, the former has a problem of heat shrinkage at a certain temperature since it inherits the characteristics of a PE microporous film expect for the meltdown temperature. On the other hand, the latter prevents heat shrinkage dramatically and has great resistance to short circuits originating from heat shrinkage. Nevertheless, in the above-described tests, little difference originating from the physical property differences between the separators was observed between the Batteries A1 and A3 of the invention, which utilized electron beam cross-linked separators, and the Batteries A2 and A4 of the invention, which utilized heat-proof layer-stacked separators. This indicates that the meltdown of separator due to local heating is a greater factor than the heat shrinkage of separator due to overall heating in the causes of the battery short circuits on overcharge.

It should be noted, however, that it is possible that the shrinkage of separator may affect differences in internal short circuits of batteries when batteries are overcharged at a current value that exceeds those in the above-described experiment, in which case the amount of heat generated from the overall battery also increases.

Although not directly related to the present invention, the advantages of the heat-proof layer-stacked separator will be mentioned additionally.

As mentioned above, the SD temperature in ordinary separators (PE separators) are set at 140° C. This is because, since it is necessary to prevent internal short circuits due to heat shrinkage, the proportion of the fuse component (low-melting point component) for lowering the SD temperature needs to be restricted below a predetermined value. In other words, if the amount of the fuse component (low-melting point component) is made large, the SD behavior starts at an early stage, enabling the cut-off of current in a state in which the charge depth is shallow. However, heat shrinkage is greater even at relatively low temperatures, leading to short circuits due to the heat shrinkage.

In contrast, the heat-proof layer-stacked separator as used in Batteries A2 and A4 of the invention can prevent heat shrinkage because of the layer other than that containing the fuse component and can, therefore, increase the proportion of the fuse component, making it possible to prevent internal short circuits due to the heat shrinkage of the separator and to lower the SD temperature (for example, to 120° C. or lower) at the same time. Therefore, it is believed that employing such a construction can improve tolerance of the batteries for overcharging even with such batteries as Comparative Batteries X3 to X5 that do not have similar configurations to the batteries according to the invention.

### SECOND EMBODIMENT

### Example B1

A battery was fabricated in the same manner as in Example A1 of the first Embodiment, except that the mass ratio of LCO and LMO in the positive electrode active material was 85:15.

The battery thus fabricated is hereinafter referred to as Battery B1 of the invention.

### Comparative Examples Y1 to Y3

Batteries were fabricated in the same manners as in Comparative Examples X1, X3, and X4 of the foregoing First Embodiment, respectively, except that the mass ratio of LCO and LMO in the positive electrode active material was 85:15

The batteries thus fabricated are hereinafter referred to as Comparative Batteries Y1 to Y3, respectively.

Experiment

The tolerance for overcharging of Battery B1 of the invention and Comparative Batteries Y1 to Y3 were studied. The results are shown in Table 3. The conditions in the experiment were the same as those in the experiment of the foregoing First Embodiment, except that the overcharge currents were 0.8 C, 1.0 C, 1.5 C, and 2.0 C.

TABLE 3

| | | Positive electrode active material | | | | | | |
|---|---|---|---|---|---|---|---|---|
| | | Second positive | First positive | | Number of batteries with short | | | |
| | | electrode | electrode active | | circuit | | | |
| | Positive | active material | material layer | | 0.8 C | 1.0 C | 1.5 C | 2.0 C |
| | Electrode | layer (Outer | (Current | | over- | over- | over- | over- |
| Battery | Structure | side) | collector side) | Separator | charge | charge | charge | charge |
| Battery B1 | Double | LMO | LCO | Electron beam | No | No | No | No |
| | layer | | | cross-linked | | | | |
| | | | | separator | | | | |
| Comparative | Double | LMO | LCO | Ordinary | No | 3/3 | 3/3 | 3/3 |
| Battery Y1 | layer | | | separator | | | | |

| | | | | | | | |
|---|---|---|---|---|---|---|---|
| Comparative | Single | LMO/LCO mixed | Ordinary | No | 3/3 | 3/3 | 3/3 |
| Battery Y2 | layer | | separator | | | | |
| Comparative | Single | LMO/LCO mixed | Electron beam | No | 2/3 | 3/3 | 3/3 |
| Battery Y3 | layer | | cross-linked | | | | |
| | | | separator | | | | |

With all the batteries, the mass ratio of LCO (LiCoO₂) and LMO (LiMn₂O₄) in the positive electrode active material was 85:15.

Table 3 clearly demonstrates that no short circuit was observed at any current values with Battery B1 of the invention. In contrast, with Comparative Batteries Y1 to Y3, many samples caused short circuits on overcharge at 1.0 C and all the samples resulted in short circuits on overcharge at 1.5 C or higher.

It is believed that these experimental results are due to the same reasons as discussed in the Experiment in the First Embodiment above.

### THIRD EMBODIMENT

### Example C1

A battery was fabricated in the same manner as in Example A1 of the First Embodiment except that the mass ratio of LCO and LMO was 50:50 in the positive electrode active material.

The battery thus fabricated is hereinafter referred to as Battery C1 of the invention.

### Comparative Examples Z1 to Z3

Batteries were fabricated in the same manners as in Comparative Examples X1, X3, and X4 of the foregoing First Embodiment, respectively, except that the mass ratio of LCO and LMO in the positive electrode active material was 50:50.

The batteries thus fabricated are hereinafter referred to as Comparative Batteries Z1 to Z3, respectively.

Experiment

The tolerance for overcharging of Battery C1 of the invention and Comparative Batteries Z1 to Z3 was studied. The results are shown in Table 4. The conditions in the experiment were the same as those in the experiment of the foregoing First Embodiment, except that the overcharge currents were 2.0 C, 2.5 C, 3.0 C, and 3.5 C.

TABLE 4

| | | Positive electrode active material | | | | | | |
|---|---|---|---|---|---|---|---|---|
| | | Second positive | First positive | | Number of batteries with short | | | |
| | | electrode | electrode active | | circuit | | | |
| | Positive | active material | material layer | | 2.0 C | 2.5 C | 3.0 C | 3.5 C |
| | electrode | layer (Outer | (Current | | over- | over- | over- | over- |
| Battery | structure | side) | collector side) | Separator | charge | charge | charge | charge |
| Battery C1 | Double | LMO | LCO | Electron beam | No | No | No | No |
| | layer | | | cross-linked | | | | |
| | | | | separator | | | | |
| Comparative | Double | LMO | LCO | Ordinary | No | 2/3 | 3/3 | 3/3 |
| Battery Z1 | layer | | | separator | | | | |

| | | | | | | | |
|---|---|---|---|---|---|---|---|
| Comparative | Single | LMO/LCO mixed | Ordinary | No | 3/3 | 3/3 | 3/3 |
| Battery Z2 | layer | | separator | | | | |
| Comparative | Single | LMO/LCO mixed | Electron beam | No | 2/3 | 3/3 | 3/3 |
| Battery Z3 | layer | | cross-linked | | | | |
| | | | separator | | | | |

With all the batteries, the mass ratio of LCO (LiCoO₂) and LMO (LiMn₂O₄) in the positive electrode active material was 50:50.

Table 4 clearly demonstrates that no short circuit was observed at any current values with Battery Cl of the invention. In contrast, with Comparative Batteries Z1 to Z3, many samples caused short circuits on overcharge at 2.5 C and all the samples resulted in short circuits on overcharge at 3.0 C or higher.

It is believed that these experimental results are due to the same reasons as discussed in the Experiment in the First Embodiment above.

Other Variations

(1) The positive electrode active material is not limited to lithium cobalt oxide and spinel-type lithium manganese oxide, and other materials may be used such as lithium nickel oxide, an olivine-type lithium phosphate, and a layered lithium-nickel compound. The thermal stabilities on overcharge and the amounts of remaining lithium in a charged state to 4.2 V of the positive electrode active materials made of these substances are shown in Table 5. Herein, it is necessary that a positive electrode active material that shows high thermal stability on overcharge be selected for the second positive electrode active material layer (the layer on the surface side of the positive electrode).

TABLE 5

| | | Amount of |
|---|---|---|
| | | remaining |
| | | lithium in |
| | Thermal | charged state |
| Type of positive electrode | stability on | to 4.2 V |
| active material | overcharge | (%) |
| Lithium cobalt oxide | Low | 40 |
| (LiCoO₂) | | |
| Spinel-type lithium | Very high | Little |
| manganese oxide | | |
| (LiMn₂O₄) | | |
| Lithium nickel oxide | High | 20-30 |
| (LiNiO₂) | | |
| Olivine-type lithium ion | Very high | Little |
| phosphate | | |
| (LiFePO₄) | | |
| Layered lithium-nickel | High | 20-30 |
| compound | | |
| (LiNi_{1/3}Mn_{1/3}Co_{1/3}O₂) | | |

Thermal stabilities on over charge were evaluated with reference to lithium cobalt oxide.

(2) Although the foregoing examples utilizes a spinel-type lithium manganese oxide alone as the active material of the second positive electrode active material layer, these are merely illustrative of the invention. It is of course possible to use, for example, a mixture of a spinel-type lithium manganese oxide and an olivine-type lithium iron phosphate as the active material of the second positive electrode active material layer. Likewise, it is possible to use a mixed material for the first positive electrode active material layer.

(3) The structure of the positive electrode is not limited to the two-layer structure, and a structure comprising three or more layers may of course be employed.

(4) The method for causing cross-linking in the separator is not limited to the electron beam cross-linking, and it is also possible to adopt a method in which cross-linking is effected chemically. The method in which cross-linking is effected chemically can also raise the meltdown temperature. However, the method in which cross-linking is effected chemically may change other physical properties of the separator greatly, and therefore, it is necessary that fine adjustments be made during the production. For this reason, it is desirable from the viewpoint of improving productivity that electron beam be used for the cross-linking.

(5) The source material used in preparing the heat-proof layer stacked separator is not limited to polyamide, and other materials such as polyimide and polyamideimide may be used. The water-soluble solvent used when preparing the heat-proof layer stacked separator is not limited to N-methyl-2-pyrrolidone but other solvents such as N,N-dimethylformamide and N,N-dimethylacetamide may also be used.

(6) The method for mixing the positive electrode mixture is not limited to the above-noted mechanofusion method. Other possible methods include a method in which a mixture is dry-blended while milling the mixture with a Raikai-mortar, and a method in which the mixture is wet-mixed and dispersed directly in a slurry.

(7) The negative electrode active material is not limited to graphite, and various other materials may be employed, such as coke, tin oxides, metallic lithium, silicon, and mixtures thereof, as long as the materials are capable of intercalating and deintercalating lithium ions.

(8) The lithium salt in the electrolyte solution is not limited to LiPF₆, and various other substances may be used, including LiBF₄, LiN(SO₂CF₃)₂, LiN (SO₂C₂F₅)₂, LiPF_{6-X}(CₙF₂ₙ₊₁)_{X} (wherein 1<x<6 and n=1 or 2), which may be used either alone or in combination of two or more of them. The concentration of the lithium salt is not particularly limited, but it is preferable that the concentration of the lithium salt be restricted in the range of from 0.8 moles to 1.5 moles per 1 liter of the electrolyte solution. The solvents for the electrolyte solution are not particularly limited to ethylene carbonate (EC.) and diethyl carbonate (DEC.) mentioned above, and preferable solvents include carbonate solvents such as propylene carbonate (PC.), γ-butyrolactone (GBL), ethyl methyl carbonate (EMC.), and dimethyl carbonate (DMC). More preferable is a combination of a cyclic carbonate and a chain carbonate.

(9) The present invention may be applied to gelled polymer batteries as well as liquid-type batteries. In this case, examples of the polymer material include polyether-based solid polymer, polycarbonate solid polymer, polyacrylonitrile-based solid polymer, oxetane-based polymer, epoxy-based polymer, and copolymers or cross-linked polymers comprising two or more of these polymers, as well as PVDF. A gelled solid electrolyte in which any of these polymer materials, a lithium salt, and an electrolyte are combined may be used.

The present invention is also applicable to large-sized batteries for, for example, in-vehicle power sources for electric automobiles or hybrid automobiles, as well as driving power sources for mobile information terminals such as mobile telephones, notebook computers, and PDAs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2004-213111, filed Jul. 21, 2004, which is incorporated herein by reference.

What is claimed is:

1. A non-aqueous electrolyte battery, comprising:
a positive electrode including a positive electrode active material-layer and a positive electrode current collector, the positive electrode active material-layer being formed on a positive electrode current collector surface and comprising a plurality of layers respectively having different positive electrode active materials, wherein an outermost positive electrode layer among the plurality of layers contains as its main active material a positive electrode active material having the highest thermal stability among the positive electrode active materials;
a negative electrode including a negative electrode active material layer; and
a separator interposed between the electrodes and having a meltdown temperature of 180° C. or higher.

2. The non-aqueous electrolyte battery according to claim 1, wherein the main positive electrode active material in the outermost positive electrode layer is a spinel-type lithium manganese oxide.

3. The non-aqueous electrolyte battery according to claim 1, wherein the positive electrode active material of the outermost positive electrode layer consists of a spinel-type lithium manganese oxide.

4. The non-aqueous electrolyte battery according to claim 1, wherein the positive electrode active material-layer contains lithium cobalt oxide as a positive electrode active material.

5. The non-aqueous electrolyte battery according to claim 4, wherein the lithium cobalt oxide is present in a lowermost positive electrode layer.

6. The non-aqueous electrolyte battery according to claim 4, wherein the total mass of the lithium cobalt oxide in the positive electrode active material-layer is greater than the total mass of the spinel-type lithium manganese oxide in the positive electrode active material-layer.

7. The non-aqueous electrolyte battery according to claim 5, wherein the total mass of the lithium cobalt oxide in the positive electrode active material-layer is greater than the total mass of the spinel-type lithium manganese oxide in the positive electrode active material-layer.

8. The non-aqueous electrolyte battery according to claim 1, wherein the separator is an electron-beam cross-linked separator, in which cross-linking is effected by irradiating a microporous polyethylene film with an electron beam.

9. The non-aqueous electrolyte battery according to claim 1, wherein the separator comprises a microporous film having a melting point of 200° C. or higher and a microporous polyethylene film, the microporous film having a melting point of 200° C. or higher adhered over the microporous polyethylene film.

10. The non-aqueous electrolyte battery according to claim 9, wherein the microporous film having a melting point of 200° C. or higher is a microporous film made of polyamide, polyimide, or polyamideimide.

11. The non-aqueous electrolyte battery according to claim 10, wherein the microporous film made of polyamide, polyimide, or polyamideimide has a melting point of from 200° C. to 400° C.
